(19) United States
(12) Patent Application Publication
(10) Pub. No.: US 2003/0160371 A1
(43) Pub. Date: Aug. 28, 2003

(54) Vibrator with resilience

(76) Inventors: David Tak-Wei Hon, Shenzen (CN); Dalai Xu, Shenzen (CN)

Correspondence Address: KNOBBE MARTENS OLSON & BEAR LLP, 2040 MAIN STREET, FOURTEENTH FLOOR, IRVINE, CA, 92614, US

(21) Appl. No.: 10/257,045

(22) PCT Filed: Feb. 26, 2001
(86) PCT No.: PCT/CN01/00149

(30) Foreign Application Priority Data
Apr. 5, 2000 (CN) 00227772.7

(51) Int. Cl. B60G 11/02; F16F 1/18

(52) U.S. Cl. 267/158; 267/47

(57) ABSTRACT

A vibrator with resilience comprised of two or more spring leafs which are jointed between a base and a bearing object, in which the respective leaf spring folds at connecting ends are parallely disposed to each other, the joint form of which might be triangle or parallelogram etc., and various completed configurations deriving from foregoing basic forms are available according to acquirement. The advantage of said vibrator is its handy structure, lower cost and easy maintenance, which can be widely used as a damper in the cases of suitable vibration scope.

### FIELD OF THE INVENTION

This invention relates to a device, which, under the influence of a restoration force, undergoes an oscillatory or vibration motion. The “oscillatory motion” here is well defined but may be irregular in time, such as those found in shock absorbing systems.

### BACKGROUND OF THE INVENTION

Various kinds of shock-absorbing devices used in vehicles generally include a bearing (37) and a spring system (38), in which most of the shock-absorbing objects such as wheel axles (8) make up-and-down movements around the bearing axis with the help of springs thus realizing the aim of shock absorption. FIG. 1 illustrates a shock-absorbing device for the rear wheel of a bicycle. These shock-absorbing devices involve a lot of parts, resulting in high costs, heavy weights, bearing abrasion, inconvenient maintenance and high requirements for rust prevention.

### AIM OF THE INVENTION

The aim of this invention is to provide a vibrator with resilience that is of simple structure, low cost, convenient maintenance, and without special rust prevention processes.

### SUMMARY OF THE INVENTION

This invention comprises at least two leaf springs, both ends of each of which are connected separately to the base and the supporting member, and the effective connecting edges thereof are parallel to one another.

In operation, the leaf springs will curve flexibly, allowing the supporting member to make movements within a certain freedom of space relative to the base, so as to realize the aim of shock absorption or oscillation. As the invention is simple, light-weight, low-cost, convenient to maintain, and requiring no complicated rust prevention processes, it can be widely used in shock-absorbing systems for vehicles, planes, snowmobiles and saddles. It can also be used for devices that need small angular or lateral oscillations. For example, the invention can be used for some optical mirrors, in which the resilience of the leaf springs can be configured according to different needs such as in resonance vibration so comparatively steady oscillations can be induced by only a small periodic load.

### BRIEF DESCRIPTION OF THE DRAWINGS

FIG. 1 illustrates a shock-absorbing device currently used for bicycles;

FIG. 2 illustrates one embodiment of this invention;

FIG. 3 illustrates another embodiment of this invention;

FIG. 4 illustrates another embodiment of this invention;

FIG. 5 illustrates another embodiment of this invention;

FIG. 6 illustrates another embodiment of this invention;

FIG. 7 illustrates another embodiment of this invention;

FIG. 8 illustrates another embodiment of this invention;

FIG. 9 illustrates another embodiment of this invention;

FIG. 10 illustrates application of this invention where it is arranged for front and rear wheel shafts and cushion;

FIG. 11 illustrates another form of application of this invention where it is used on a saddle;

FIG. 12 illustrates another form of application of this invention where it is used on a handlebar;

FIG. 13 illustrates a third form of application of this invention where it is used on a saddle;

FIG. 14 illustrates application of this invention where it is used for an optic mirror for oscillating a beam over a certain angle;

FIG. 15 illustrates application of this invention where it is used for optic mirror for scanning a beam laterally.

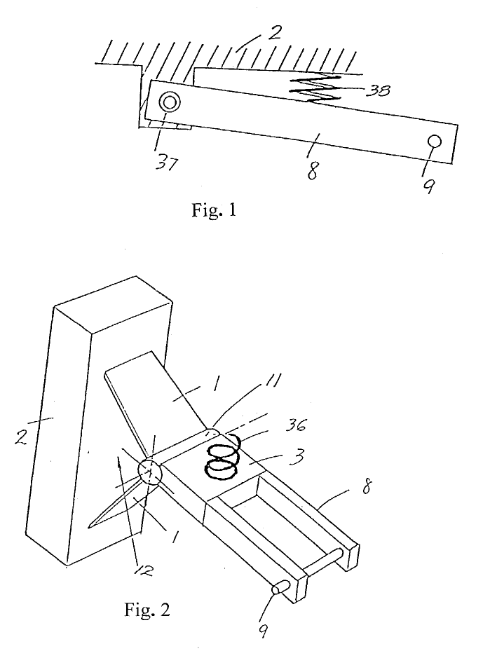

### DETAILED DESCRIPTION OF THE PREFERRED EMBODIMENTS

Embodiment 1

As illustrated in FIG. 2 of this invention, both ends of the two leaf springs 1 are secured separately to the base 2 and the supporting member 3 by means of welding, the spring 1 and the base 2 forming a structural unit of triangle section 12, where the included angle between two springs is preferred to be of 90°. Under the influence of external forces, the springs will curve flexibly, so that the supporting member 3 will rotate around the intersection 11 of the two leaf springs. As long as the leaf springs are not bent beyond the point of submission, the intersection point 11 becomes a center of rotation with restoration forces. Although there is no real physical axis here, the intersecting line 11 is a virtual axis of rotation, which, along with the leaf springs, forms a basic structure for shock-absorbing devices. In practical applications, a wheel shaft, etc. can be fixed directly onto the supporting member, or, a fork can be fixed onto the supporting member, and then connected to the wheel shaft. Of course, when the springs 1, the base 2 and the supporting member 3 form a section of triangular structure, it will have the same effect.

Embodiment 2

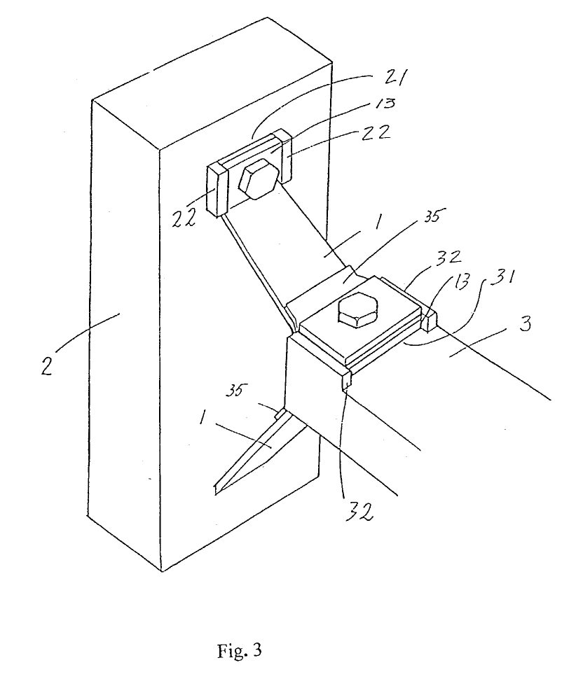

The springs 1 can be connected with the base 2 or the supporting member 3 by corresponding coupling surfaces, such as tooth-to-tooth coupling, tooth-to-slot coupling, etc. Being pressed, these coupling surfaces will have strong coupling and inter-locking effect. For example, the connection of the springs 1 with the base 2 and the supporting member 3 can adopt the means shown in FIG. 3, where base 2 and the supporting member 3 respectively have surfaces 21 and 31, with position-limiting flanges 22 and 32 on both sides of surfaces 21 and 31 respectively, and springs 1 have coupling surfaces 13 on them which are extending outwards and can be coupled with the position-limiting flanges, and they are pressed closely and secured with screws or bolts.

Embodiment 3

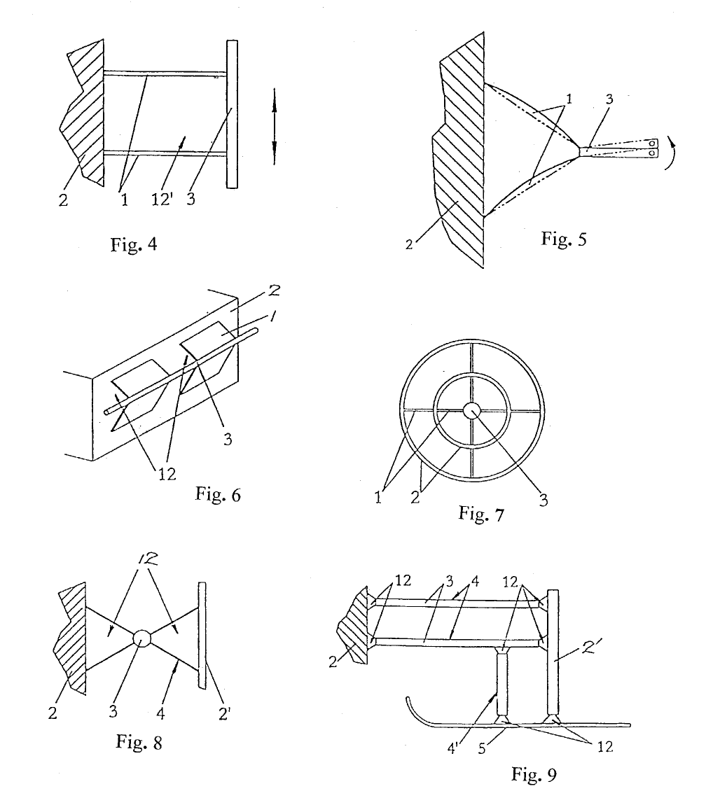

As shown in FIG. 4, two springs 1 along with the base 2, the supporting member 3, form a structural unit of parallelogram section 12′.

In order to distribute stress more evenly so that the stress will not concentrate on portions of the leaf springs adjacent to the supporting member, the springs are arranged in a form with different widths such as an echelon (or something like an echelon), in which the wider side of the spring 1 is connected to the supporting member 3 and the smaller side in connected to base 2. A strengthening piece 35 can also be added to the supporting member, or the thickness of the spring adjacent to the supporting member can be increased as shown in FIG. 3. Of course, the same can also be applied to the connection between the springs and the base. All of the above measures will increase the lifespan of this invention. Besides, additional springs 36 can be arranged for the system in order to give different flexural strengths as required, as shown in FIG. 2.

Embodiment 4

As shown in FIG. 5, each leaf spring can be pre-curved so as to increase structural rigidity in the other 5 degrees of freedom when loading straightens the spring. Other structures of this embodiment are similar to those in Embodiment 1.

The number of leaf springs shall of course not necessarily be limited to two. But they must be arranged so that their flexing will not interfere with each other in operation. In practical applications, various complicated structures formed with structural unit 12 or 12′ mentioned above can be adopted as in the following embodiments.

Embodiment 5

As shown in FIG. 6, there are two triangle structural units 12 transversely paralleled on base 2; each spring 1 is connected to the same supporting member 3 so as to increase rigidity of the whole structure.

Embodiment 6

As shown in FIG. 7, base 2 is of two layers of coaxing cylinders, the supporting member 3 is the axis of the cylinders, and the springs are connected between the base 2 and the supporting member 3 in radiating form.

Embodiment 7

As shown in FIG. 8, two triangle structural units 12 are abutted to form component 4 with one supporting member 3 and one of the bases 2 becomes a mobile platform 2′. This kind of mobile platform has bigger turning range.

Embodiment 8

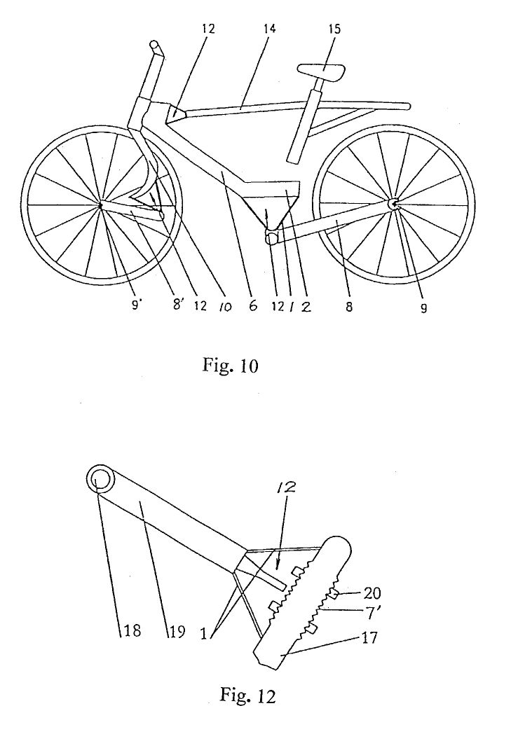

FIG. 9 is a more complicated structure, where the supporting member 3 of the component 4 is in the shape of a rod, and there are two parallel components 4 connecting base 2 and the mobile platform 2′, one end of which is connected to working platform 5 through the triangular structural units 12, and the working platform forms the base of the triangle structural unit. In practical applications, working platform 5 is the blade of the sled or snowmobile, and the base is the frame of the vehicle.

In the structure as shown in FIG. 9, there is another component 4′ connecting the supporting member 3 of one of the components 4 and the working platform 5. Component 4′ is parallel to the mobile platform 2′ keeping the blade horizontal while absorbing vertical shocks.

In practical applications of this invention, the base 2 and the supporting member 3 can be evolved into suitable and specific structures. The following are examples of various shock-absorbing applications of this invention in bicycles.

Embodiment 9

FIG. 10 illustrates an application of a triangular structural unit 12 in bicycles, in which the bottom tube 6 of the frame is the base 2, one end of the fork 8 is connected to spring 1, and the other end to the rear axle 9.

Embodiment 10

As shown in FIG. 10, the front axle 9′ is secured indirectly to the traditional front fork 10 as the base and the level fork 8′ as the supporting member, one end of which is connected to the spring system 12′ and the other end is connected to front axis 9′. The same structure can be used on one or both sides of the front wheel.

There are also many ways of shock absorption with the saddles.

Embodiment 11

As shown in FIG. 10, the bottom tube 6 of bicycle frame is used as the base, cross bar 14 as the supporting member. Leaf springs 1 are connected to one end of the cross bar and to the top of bottom tube. Cushion 15 is secured on cross bar 14.

Embodiment 12

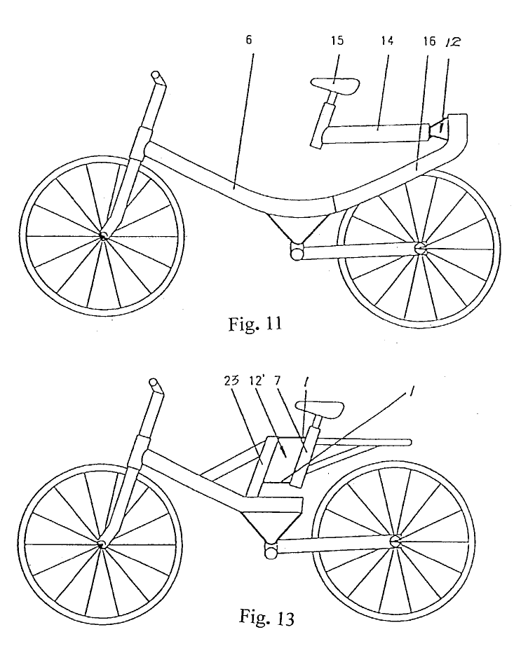

As shown in FIG. 11, a connecting tube 16 is secured at the rear end of bottom tube 6 which extend backwards and used as the base. Cross bar 14 on which the cushion 15 is secured is the supporting member, and the leaf springs are connected to the rear end of the cross bar and the rear end of the connecting tube.

Embodiment 13

FIG. 12 illustrates another application of this invention, in which the triangular structural unit is used on a shock-absorbing handle bar, with the stem tube 17 serve as the base and the fixed tube 19 of the handlebar 18 as the supporting member. There is a position-limiting device on the tube 17, screw thread 7′ is matched with position-adjusting nuts 20, which limits the range of travel of the end of the fixed tube 19, An overall shock-absorbing device is thus accomplished.

Embodiment 14

FIG. 13 illustrates another application of this invention, in which the parallelogram structural unit 12′ is used for the saddle. An oval tube 23 is secured on top of the bicycle frame in parallel with cushion tube 7; Leaf springs 1 is connected in parallel between the oval tube 23 and saddle tube 7 so that the saddle has the effect of up and down shock suspension.

Embodiment 15

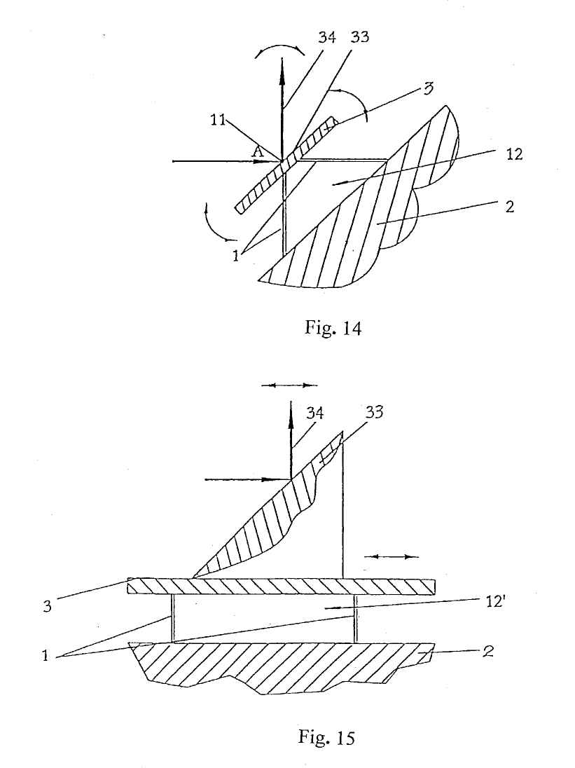

As shown in FIG. 14, in the triangular structural unit 12, a mirror 33 is secured on the supporting member 3, the intersecting point 11 of the spring 1 is located on the reflecting surface of the mirror 33, the vibration of the mirror can be controlled by a motor or resonance vibration, so that when the light beam is reflected from the mirror, it will have an angular vibration.

Embodiment 16

As shown in FIG. 15, a parallelogram structural unit 12′ is adopted so that when the light beam 34 is reflected from the mirror, it will have a lateral vibration:

In order to meet various practical requirements, as in many traditional shock-absorbing systems, movement-limiting devices, damping devices, or other shock-absorbing devices can be added to this invention for better comfort or safety.

What is claimed is:

1. A vibrator with resilience, characterized in that, comprising at least two leaf springs (1), both ends of each of the leaf springs (1) are connected separately to the base (2) and the supporting member (3), and the connecting edges thereof are parallel to one another.

2. A vibrator with resilience according to claim 1, characterized in that, the leaf spring (1) are arranged in a form with different widths such as an echelon.

3. A vibrator with resilience according to claim 1, characterized in that, the leaf springs (1) has larger effective thickness adjacent to the base (2) or the supporting member (3) than at other places.

4. A vibrator with resilience according to claim 2, characterized in that, the spring (1) is slightly curved.

5. A vibrator with resilience according to claim 1, characterized in that, the springs (1) are connected with the base (2) or the supporting member (3) by way of pressing closely corresponding coupling surfaces.

6. A vibrator with resilience according to claim 5, characterized in that, the base (2) or the supporting member (3) has a surface (21) or (31) on it, the extending coupling surface (13) on the spring (1) is coupled with surface (21) or (31), and they are pressed closely and secured with screws or bolts.

7. A vibrator with resilience according to claim 6, characterized in that, the surface (21) or (31) has position-limiting flanges (22) or (32) on both sides, and the coupling surface of the spring is coupled with the surface of the position-limiting flanges.

8. A vibrator with resilience according to claim 1, characterized in that, the two springs (1) and the base (2) form a structural unit of triangle section (12);

9. A vibrator with resilience according to claim 1, characterized in that, the two springs (1) and the supporting member (3) form a structural unit of triangle section.

10. A vibrator with resilience according to claim 8 and 9, characterized in that, the included angle of the two springs (1) is preferred to be of 90°.

11. A vibrator with resilience according to claim 1, characterized in that, the spring (1), the base (2) and the supporting member (3) form a structural unit of a parallelogram (12) or a similarity of a parallelogram.

12. A vibrator with resilience according to claim 8, characterized in that, on the base (2) there are two structural units (12) transversely in parallel with each other, and connected to the same supporting member (3).

13. A vibrator with resilience according to claim 1, characterized in that, the base (2) is of one or more layers of coaxing cylinders with the supporting member (3) as the axis of the coaxing cylinders, and the springs (1) are connected between the base (2) and the supporting member (3) in a radiating form.

14. A vibrator with resilience according to claim 8, characterized in that, a pair of triangle structural units (12) are abutted to form a component (4), sharing one supporting member (3), and one of the bases (2) forming a mobile platform (2′).

15. A vibrator with resilience according to claim 14, characterized in that, the supporting member is of rod shape and there are two parallel components (4) connected between the base (2) and the mobile platform (2′), one end of the mobile platform (2′) is connected to the working platform (5) through triangular structural units (12), and the work platform (5) as the base in the triangular structural units.

16. A vibrator with resilience according to claim 15, characterized in that, between the supporting member (3) of one of the components and the work platform (5), there is also a connecting component (4′) which is in parallel with the mobile platform (2′).
